(19) United States
(12) Patent Application Publication
(10) Pub. No.: US 2005/0178868 A1
(43) Pub. Date: Aug. 18, 2005

(54) Fishing reel of the multiplier type

(76) Inventor: Patrik Svensson, Asarum (SE)

Correspondence Address: HARNESS, DICKEY & PIERCE, P.L.C., P.O. BOX 8910, RESTON, VA, 20195, US

(21) Appl. No.: 11/048,898

(22) Filed: Feb. 3, 2005

(30) Foreign Application Priority Data
Feb. 16, 2004 (SE) 0400331-5

(51) Int. Cl. A01K 89/02

(52) U.S. Cl. 242/247

(57) ABSTRACT

A fishing reel of the multiplier type has a frame, a shaft rotatably mounted in the frame, a device for braking the shaft, and a line spool mounted on the shaft. A handle is arranged to rotate by a drive mechanism the line spool in a direction of retrieval for rewinding onto the line spool a part, paid out from the line spool, of a line wound onto the same. The line spool is rotatably mounted on the shaft. A freewheeling hub is arranged between the line spool and the shaft so as to allow rotation of the line spool relative to the shaft in the direction of retrieval but prevent rotation of the line spool relative to the shaft in the opposite direction.

### FIELD OF THE INVENTION

The present invention relates to a fishing reel of the multiplier type, comprising a frame, a shaft rotatably mounted in the frame, a device for braking the shaft, a line spool mounted on the shaft, a handle which is arranged to rotate by a drive mechanism the line spool in a direction of retrieval for rewinding onto the line spool a part, paid out from the line spool, of a line wound onto the same.

### BACKGROUND ART

In prior-art fishing reels of this type, the brake device usually consists of a friction brake, whose braking effect is adjustable by means of an adjusting knob to achieve the desired braking of the shaft and, thus, of the line spool which is non-rotatably mounted thereon. The purpose of the braking is to prevent the line spool, during casting, from rotating at such a high speed that the line cannot be paid out at the same rate but instead rises, forming a so-called bird nest. In the subsequent retrieving for rewinding of the paid-out part of the line onto the line spool, i.e. when the shaft and the line spool rotate in the direction opposite to the direction of rotation during casting, the direction of retrieval, the shaft and the line spool are braked in the same manner by the brake device if the adjusting knob is not operated to reduce or cancel the braking effect of the brake device. However, such operation is so difficult to perform while fishing that the angler normally does not change the braking effect of the brake device after casting. As a result, the line spool is braked also during retrieval, which reduces the angler's capacity for detecting and flexibly parrying the movements of a fish that has taken the bait attached to the end of the line, thus also reducing the angler's possibility of taking up the fish.

### SUMMARY OF THE INVENTION

The object of the invention therefore is to provide a fishing reel, in which the line spool can be braked during casting so as to prevent the line from rising and in which the effect of the brake device on the line spool is automatically cancelled when retrieving the line.

According to the invention, this object is achieved by a fishing reel, which is of the type stated by way of introduction, the line spool being rotatably mounted on the shaft, a freewheeling hub being arranged between the line spool and the shaft so as to allow rotation of the line spool relative to the shaft in the direction of retrieval but prevent rotation of the line spool relative to the shaft in the opposite direction.

As a result, the line spool rotates with the braked shaft during casting, but rotates freely in relation to the braked shaft in retrieval, which increases the angler's possibilities of taking up fish.

In a preferred embodiment, the line spool is rotatably mounted on the shaft by two axially spaced-apart ball bearings, between which the freewheeling hub is placed.

### BRIEF DESCRIPTION OF THE DRAWINGS

The invention will now be described in more detail by way of a preferred embodiment and with reference to the accompanying drawings.

FIG. 1 is a longitudinal section of a fishing reel according to the present invention.

FIGS. 2 and 3 are enlarged cross-sectional views along line II-II in FIG. 1 and illustrate a freewheeling hub in two different positions.

### DESCRIPTION OF A PREFERRED EMBODIMENT

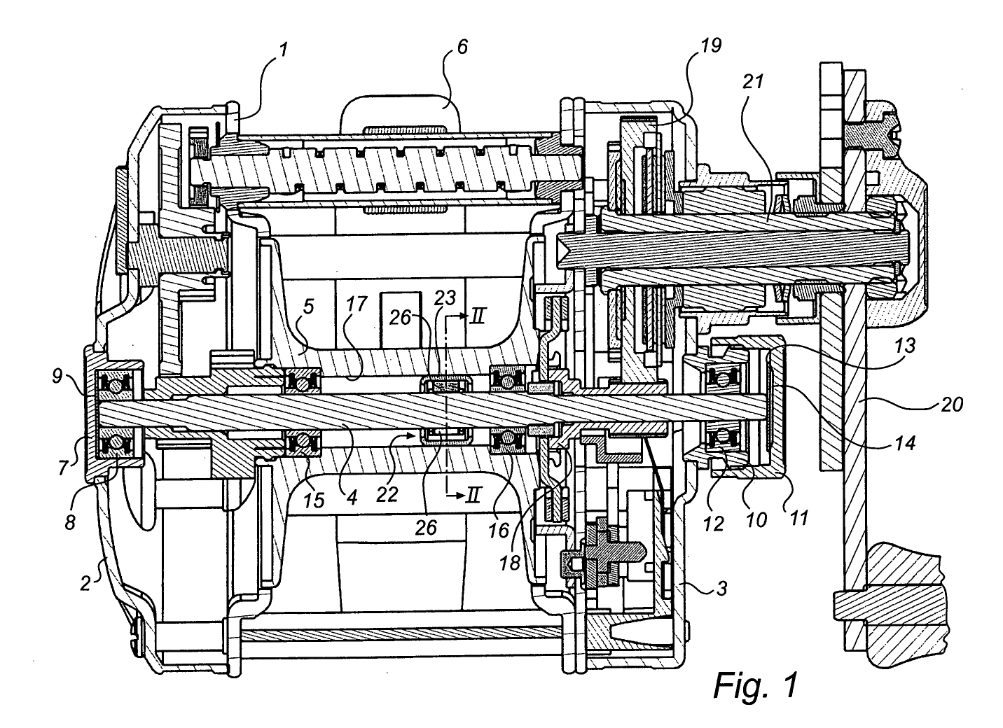

The fishing reel shown in FIG. 1, which is of the multiplier type, has a frame 1, two side plates 2 and 3, a line spool shaft 4 rotatably mounted in the frame 1, a line spool 5 mounted on the shaft 4 and intended for a line (not shown), and a foot 6 for mounting the fishing reel on a fishing rod (not shown).

The left end of the shaft 4 is inserted into a cup-shaped bearing housing 7, which is attached to the left side plate 2. The shaft 4 is rotatably mounted in the bearing housing 7 by a ball bearing 8 and rests with its end face against a friction washer 9, which abuts against the bottom of the cup-shaped bearing housing 7.

The right end of the shaft 4 extends through a sleeve-shaped bearing housing 10, which is attached to the right side plate 3, into a cup-shaped adjusting knob 11, which is screwed on the bearing housing 10. The shaft 4 is rotatably mounted in the bearing housing 10 by a ball bearing 12 and rests with its end face against a friction washer 13, which abuts against the bottom of the cup-shaped knob 11. The friction washer 13, which is slightly yieldable, is placed over a shallow recess 14 in the bottom of the knob 11.

The two friction washers 9 and 13 together form a mechanical brake, which is arranged to brake the rotation of the shaft 4 and whose braking effect on the shaft is adjustable by turning of the knob 11.

The line spool 5 is rotatably supported on the shaft 4 by two ball bearings 15 and 16, which are mounted a distance into the line spool 5 in a through center hole 17 in the same.

A clutch means in the form of a clutch sleeve 18 provided with external gear teeth is rotatably and axially displaceably mounted on the shaft 4. The right end of the clutch sleeve 18 meshes with a driving gear 19, which is non-rotatably mounted on a drive shaft 21 rotatable by a handle 20 which is only partly shown.

The clutch sleeve 18 is shown in FIG. 1 in an engaging position, in which the left end thereof in prior-art manner (not shown) is drivingly engaged with the line spool 5. When a cast is to be made, the clutch sleeve 18 is displaced in prior-art manner by a trigger (not shown) to the right to a disengaging position, in which it is disengaged from the line spool 5.

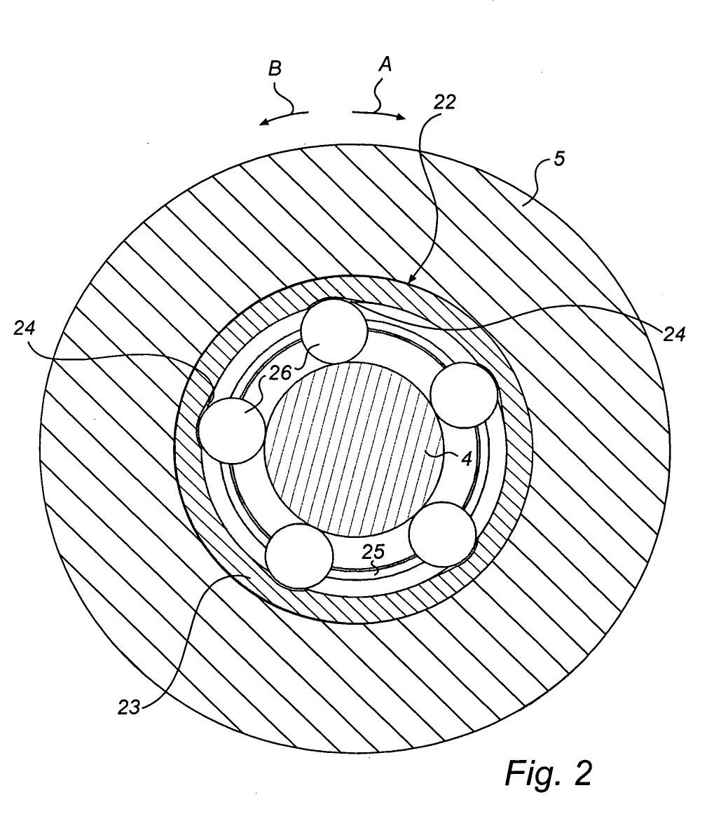

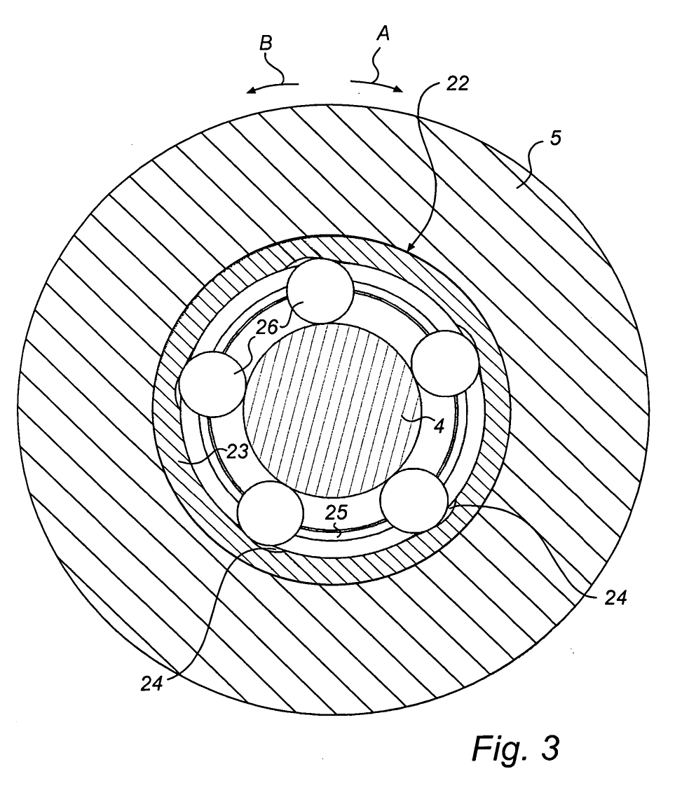

When, after a cast has been made, the angler starts turning the handle 20 for rotation of the line spool 5 in the direction of retrieval A (see FIGS. 2 and 3), i.e. the direction in which that part of a line attached to the line spool 5 which is paid out during casting is again wound onto the spool, the clutch sleeve 18 is in prior-art manner automatically returned to its engaging position for rotation of the line spool 5.

The line spool 5 is supported on the shaft 4 not only by the two axially spaced-apart ball bearings 15, 16 but also by a freewheeling hub 22, which is placed between these ball bearings. The freewheeling hub 22, which is shown in more detail in FIGS. 2 and 3, has an outer cylindrical housing 23, whose outer diameter essentially corresponds to the diameter of the center hole 17 of the line spool 5 and which is fixed in this hole 17 by a press fit. The housing 23 has on its inside a plurality of axially extending grooves 24, which are uniformly distributed in the circumferential direction. The freewheeling hub 22 also has a cylindrical holder 25, which rotatably holds a roll 26 extending in the axial direction of the housing 23 just in front of each of the grooves 24. The rolls 26 abut against the shaft 4 and extend into the respective grooves 24.

The grooves 24 have a rear portion seen in the clockwise direction A (with regard to FIGS. 2 and 3), which has such a cross-sectional shape and depth that each roll 26, when positioned just in front of this rear portion, is freely rotatable in the holder 25, thus allowing the housing 23 and also the line spool 5 to rotate freely on the shaft 4 (FIG. 2). The grooves 24 also have a front portion seen in the clockwise direction A, which has such a depth decreasing in the clockwise direction that the respective rolls 26 on rotation of the housing 23 in the counterclockwise direction B relative to the holder 25 are pressed harder and harder against the shaft 4 and thus are wedged between the housing 23 and the shaft 4, so that the housing 23 and thus the line spool 5 are locked to the shaft 4 and cannot rotate relative to the same (FIG. 3).

When a cast is to be made, the braking effect of the mechanical brake 9, 13 on the shaft 4 is adjusted by the knob 11 to the desired value. During casting, the line spool 5 rotates in the counterclockwise direction B, which means that the housing 23 and the ball holder 25 of the freewheeling hub 22 immediately take the position relative to each other shown in FIG. 3, so that the line spool 5 is locked to the braked shaft 4 and thus carries this along in its rotary motion. Consequently the rotation of the line spool 5 is braked during casting.

When the handle 20 is then turned and rotates the line spool 5 in the clockwise direction A, i.e. the direction of retrieval, the housing 23 and the roll holder 25 of the freewheeling hub 22 take the position relative to each other shown in FIG. 2, in which the rolls 26 are released and the line spool 5 thus rotates freely on the braked shaft 4. During rotation of the line spool 5 in the direction of retrieval A, thus no braking of the line spool occurs, which means that the angler can easily detect and flexibly parry the movements of a fish which has taken a bait attached to the end of the fishing line.

1. A fishing reel of the multiplier type, comprising a frame, a shaft rotatably mounted in the frame, a device for braking the shaft, a line spool mounted on the shaft, a handle which is arranged to rotate by a drive mechanism the line spool in the direction of retrieval for rewinding onto the line spool a part, paid out from the line spool, of a line wound onto the same, the line spool being rotatably mounted on the shaft, a freewheeling hub being arranged between the line spool and the shaft so as to allow rotation of the line spool relative to the shaft in the direction of retrieval but prevent rotation of the line spool relative to the shaft in the opposite direction.

2. A fishing reel as claimed in claim 1, wherein the line spool is rotatably mounted on the shaft by two axially spaced-apart ball bearings, between which the freewheeling hub is placed.
